(19) United States
(12) Patent Application Publication
(10) Pub. No.: US 2013/0277432 A1
(43) Pub. Date: Oct. 24, 2013

(54) Laminate Structure for a Chip Card and Method for the Production Thereof

(71) Applicants: Rungnattha Katworapattra, Phrae (TH); Edith Genevieve Therese Dangeard, Bangkok (TH); Egon Konopitzky, Chatel St. Denis (CH); Mitchell Peter Deyoung, Oceanside, CA (US)

(72) Inventors: Rungnattha Katworapattra, Phrae (TH); Edith Genevieve Therese Dangeard, Bangkok (TH); Egon Konopitzky, Chatel St. Denis (CH); Mitchell Peter Deyoung, Oceanside, CA (US)

(21) Appl. No.: 13/634,291

(22) PCT Filed: Feb. 17, 2011
(86) PCT No.: PCT/EP2011/000752

§ 371 Date: Dec. 21, 2012

(30) Foreign Application Priority Data
Mar. 15, 2010 (DE) 10 2010 011 517.7

(51) Int. Cl. G06K 19/077

(52) U.S. Cl. CPC G06K 19/07722
USPC 235/488; 156/293

(57) ABSTRACT

The invention relates to a laminate structure (30) for a chip card (31), comprising a base layer (35), a chip module (32) accommodated at least partially in the base layer, and at least one cover layer (39) that covers the base layer, wherein an intermediate space (61) formed between the chip module and the cover layer as well as between the chip module and the base layer is filled with an adhesive material, wherein the adhesive material generates adhesive forces with respect to the wetted surfaces of the base layer and of the cover layer and generates adhesive forces with respect to the wetted surfaces of the chip module as well.

The instant invention relates to a laminate structure for a chip card comprising a base layer, a chip module accommodated at least partially in the base layer, and at least one cover layer that covers the base layer, wherein an intermediate space formed between the chip module and the cover layer as well as between the chip module and the base layer is filled with an adhesive material. The invention furthermore relates to a method for producing such a laminate structure.

Chip cards, regardless of their embodiment as contact cards or contactless cards, are subject to changing bending stresses during use, which often leads to cracking and delaminations in the laminate structure. In that context the area of the chip card that accommodates the chip module turns out to be particularly endangered, because a relative movement can occur between the chip module and the adjoining coatings or layers of the laminate structure due to dynamic bending stresses.

The result of this known phenomenon is that chip cards typically only have a very limited durability, which in fact does not impede the use of chip cards in many cases, in particular in those cases where only a temporally very limited use of the chip cards is intended anyway, as is the case with credit cards or telephone cards, for example. Other fields of application, however, seem to preclude the use of chip cards due to this limited durability.

This applies in particular to the field of identity documents, when assuming that personalized identity documents, such as identity cards, for example, are typically issued for a period of ten years. It is true that certain materials, such as polycarbonate, for example, have already proven to be particularly suitable as layer material for the production of a laminate structure, because, regardless of dynamic stresses, polycarbonate on principle already has a higher resistance to ageing than PVC, which typically exhibits ageing-related cracks after as little as four to five years and which is thus basically less suitable for producing chip cards that must have a higher durability.

Polycarbonate, however, has the disadvantage that, when being used as layer material of a laminate structure, cracks can form in the interior of the laminate structure due to the afore-mentioned relative movements between the chip module and the laminate structure, wherein such cracks spread quickly through the laminate structure after having been created and then also reach the card surface.

In the production of chip cards, so-called filler materials are regularly used, which serve the purpose of arranging a chip module being inserted in a window opening of a laminate structure in a defined manner in the laminate structure or in the window opening, respectively. It is true that the filler materials used for this purpose, which are typically produced on an epoxy basis, make it possible to produce a filling of intermediate spaces formed between the chip module and the window opening, so that a fixation of the chip module in the laminate structure is possible at least initially. With this filling of the intermediate spaces, a defined positive connection between the chip module and the window opening is made possible in the laminate structure at least temporarily. However, this positive connection turns out to obviously not be sufficient to ensure a force-fit connection between the chip module and the surrounding laminate structure, which would also withstand changing bending stresses for a sufficiently long period of time.

It is thus the object of the instant invention to propose a laminate structure for a chip card as well as a method for the production thereof, which enables the production of chip cards with an improved resistance to cracking and thus an enhanced durability.

In order to attain this object, the laminate structure according to the invention encompasses the features of claim 1. The method according to the invention encompasses the features of claim 11.

According to the invention, an adhesive material which generates adhesive forces with respect to the surfaces of the base layer and the cover layer and generates adhesive forces with respect to the surfaces of the chip module as well is used for the laminate structure. Due to the above characteristics, the adhesive material is able to establish a force-fit connection between the chip module and the laminate structure that surrounds the chip module, so that, in contrast to the use of filler materials which are produced on an epoxy basis, not only a filling of intermediate spaces is obtained so as to establish a positive connection, but actually a force-fit connection, which also withstands changing bending stresses between the chip module and the surrounding laminate structure, is produced. Relative movements of the chip module with respect to the surrounding laminate structure are thus not possible. A correspondingly induced cracking is thus effectively prevented.

In particular, the enveloping arrangement of the chip module in the adhesive material creates a virtually monolithic accommodating structure for the chip module, so that, due to this structure which is connected in a force-fitting manner both to the chip module and to the surroundings of the chip module, substantially all of the bending and shear stresses are sustained across the periphery of the structure, when the card is subjected to bending stresses.

Preferably, the adhesive material is chosen such that the ratio of the adhesive forces generated in relation to the base layer and the cover layer with respect to the adhesive forces generated in relation to the chip module is 0.5 to 1.5. It is thus ensured that the adhesive forces in relation to the cover layer or the base layer, respectively, and the adhesive forces in relation to the chip module have a comparable magnitude, so that a sufficient force-fit connection is ensured, regardless of the kind of material transition, i. e. whether it is a material transition from the adhesive material to the cover layer or base layer, respectively, or from the adhesive material to the chip module.

It is particularly advantageous when the adhesive material is made on an acrylate base.

Preferably, the adhesive material encompasses more than 50 percent by weight of acrylate.

In particular in view of the production process for the laminate structure, it turns out to be advantageous when the adhesive material is made of a layer material which is provided with an acrylate coating on both sides.

On principle, it should be noted that the laminate structure turns out to be advantageous regardless of the type of chip card, when focusing on preventing cracking in the card body. However, the positive characteristics, which have already been described above, have a particularly advantageous effect when the base layer of the laminate structure is formed as a transponder layer, comprising an antenna arrangement which is formed on the transponder layer, and the contact ends of said antenna arrangement are contacted with terminal faces of the chip.

In the case of such a laminate structure, which enables the production of a contactless chip card, a stressable force-fit connection between the chip module and the surrounding layers of the laminate structure is particularly important, because such chip cards, which are used as identity documents, in particular identity cards, must have a particularly high durability and reliability.

Preferably, the top side of the chip module is hereby covered by a top layer arranged on the cover layer, and the bottom side thereof is covered by a bottom layer arranged on the transponder layer, wherein at least one window opening formed in the cover layer and a window opening formed in the transponder layer, which define an accommodating space for arranging the chip module, are in each case covered with an adhesive material coating which extends between the top side of the chip module and the top layer as well as between the bottom side of the chip module and the bottom layer.

Such a “sandwich layer” of the chip module formed between adhesive material coatings ensures a particularly reliable and permanently durable arrangement of the chip module in the laminate structure, in the case of which relative movements of the chip module are effectively prevented due to the adhesive material coating on both sides.

This applies regardless of whether the transponder layer and the cover layer are formed in the initial state as layers being independent of one another, or whether an inlay layer, which is formed in one piece, is used instead.

A force-fit accommodation of the chip module in the laminate structure, with force introductions between the adhesive material coating and the surroundings being at the same time as extensive as possible, is enabled when the adhesive material coating arranged on the top side of the chip module and the adhesive material coating arranged on the bottom side of the chip module in each case extend beyond the edge of the window opening between the top layer and the cover layer as well as between the bottom layer and the transponder layer.

Particularly advantageously, the advantages of the laminate structure according to the invention become obvious when at least the base layer and/or the cover layer are formed from polycarbonate.

In the method according to the invention for producing a laminate structure for a chip card comprising a base layer, a chip module being accommodated at least partially in the base layer, and at least one cover layer that covers the base layer, prior to a laminating process for producing a laminated connection, an adhesive material deposit is arranged between the cover layer and the chip module as well as between the base layer and the chip module, the volume of said adhesive material deposit being dimensioned such that an intermediate space formed between the chip module and the cover layer as well as between the chip module and the base layer is filled with the adhesive material during the laminating process, wherein a material is used as an adhesive material, which generates adhesive forces with respect to the surfaces of the base layer and of the cover layer being wetted during the laminating process and generates adhesive forces with respect to the wetted surfaces of the chip module as well.

In the method according to the invention, already prior to carrying out the actual laminating process, provision of adhesive material deposits is made at different locations of the laminate structure, namely assigned to the bottom side of the chip module on the one hand and assigned to the top side of the chip module on the other hand, so that a particularly uniform distribution of the adhesive material is obtained during the subsequent laminating process, resulting in the adhesive forces, which are advantageously generated by the adhesive material in relation to the layers of the laminate structure and in relation to the chip module as well, attaining a corresponding distribution in the laminate structure.

In this context it turns out to be particularly advantageous when the adhesive material deposit is formed as an adhesive material layer which is inserted into an accommodating space formed in the layer structure for accommodating the chip module, such that the adhesive material layer covers the surface that delimits the accommodating space. Thus, for example in the case of a chip card which is formed as a contact card and where the chip module is accommodated in a window opening which is open towards the outer side of the card body, the adhesive material deposit can be inserted as a lining for the window opening prior to carrying out the laminating process, the chip module can subsequently be inserted into the window opening being lined by the adhesive material layer, and in the subsequent laminating process a laminated connection can finally be established between the cover layer and the base layer and the chip module via the adhesive material layer.

When the adhesive material layer is inserted into the accommodating space such that edges of the adhesive material layer project beyond the surface of the cover layer, it is ensured that a transition which is flush-fitting and free from flaws is formed between an outer contact surface of the chip module and the adjoining cover layer by means of the subsequent laminating process.

When the method is used for producing a contactless chip card, it is particularly advantageous, in the case of the base layer being formed as a transponder layer comprising an antenna which is formed on the transponder layer and the contact ends of which are contacted with terminal faces of the chip module, when the adhesive material deposit is formed as an adhesive material layer being arranged between a top side of the chip module and a top layer that covers the cover layer, as well as between the bottom side of the chip module and a bottom layer that covers the transponder layer, wherein the edges of the adhesive material layer project beyond a window opening which is in each case formed in the cover layer and in the transponder layer.

Regardless of the fact that, according to this preferred method alternative, a laminate structure for a contactless chip card is created, in which the chip module is accommodated between two adhesive material layers in a sandwich-like manner, this method alternative makes it possible to optionally apply the adhesive material deposit, which is formed as an adhesive material layer, prior to the laminating process either onto the top side and the bottom side of the chip module, or to apply the adhesive layer onto the side of the top layer or the bottom layer respectively facing the chip module.

In particular the last-mentioned method alternative, i. e. the application of the adhesive material layers onto the bottom layer or the top layer, respectively, makes it possible to carry out the application of the respective adhesive material layer onto the bottom layer and the top layer of the laminate structure in a production line in which the different layers of the laminate structure are supplied as endless material layers being formed in a linear manner prior to joining the material layers, so that the application of the material layers, for example, can take place synchronously with the production of the window openings in the cover layer.

The adhesive material layers can be formed as adhesive patches—and thus so as to be capable of being handled independently—and can be applied onto the bottom layer and the top layer or, in the alternative, onto a top and bottom side of the chip module.

Preferred embodiments of the laminate structure will be explained in more detail below by means of the drawings.

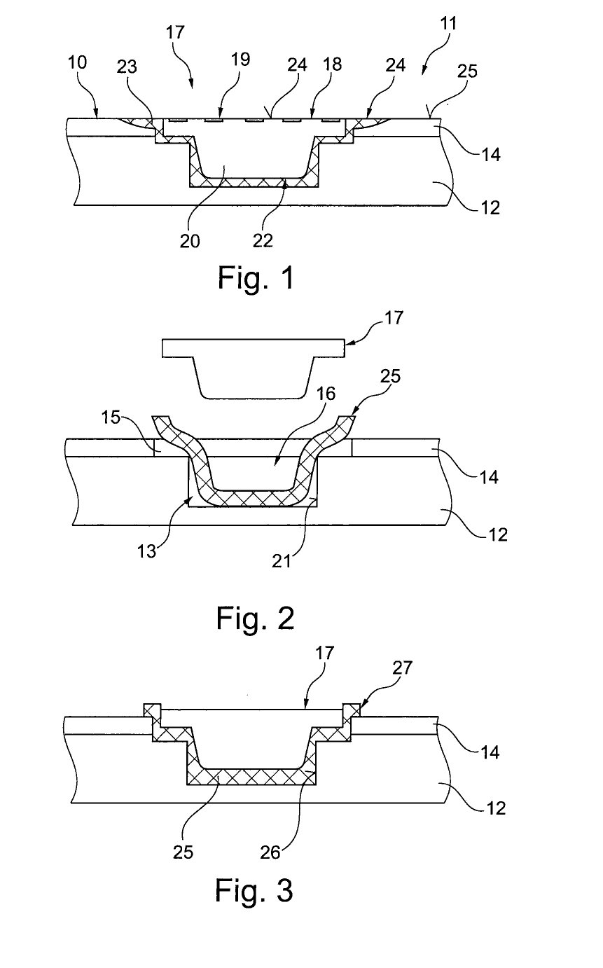

FIG. 1 shows a laminate structure for a chip card formed as a contact card after the laminating process;

FIG. 2 shows the laminate structure illustrated in FIG. 1 prior to the insertion of a chip module;

FIG. 3 shows the laminate structure illustrated in FIG. 1 after the insertion of the chip module and prior to carrying out the laminating process;

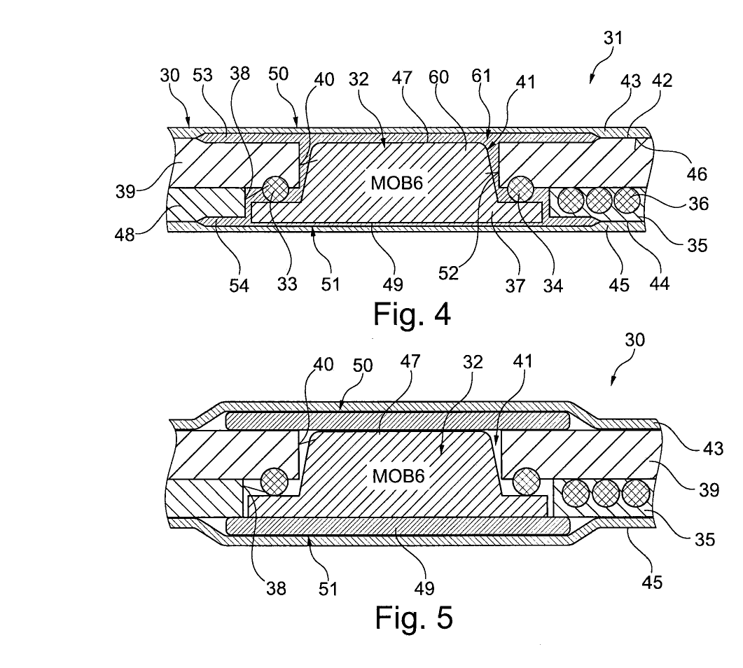

FIG. 4 shows a laminate structure for a chip card formed as a contactless card after the laminating process;

FIG. 5 shows the laminate structure illustrated in FIG. 4 prior to the laminating process;

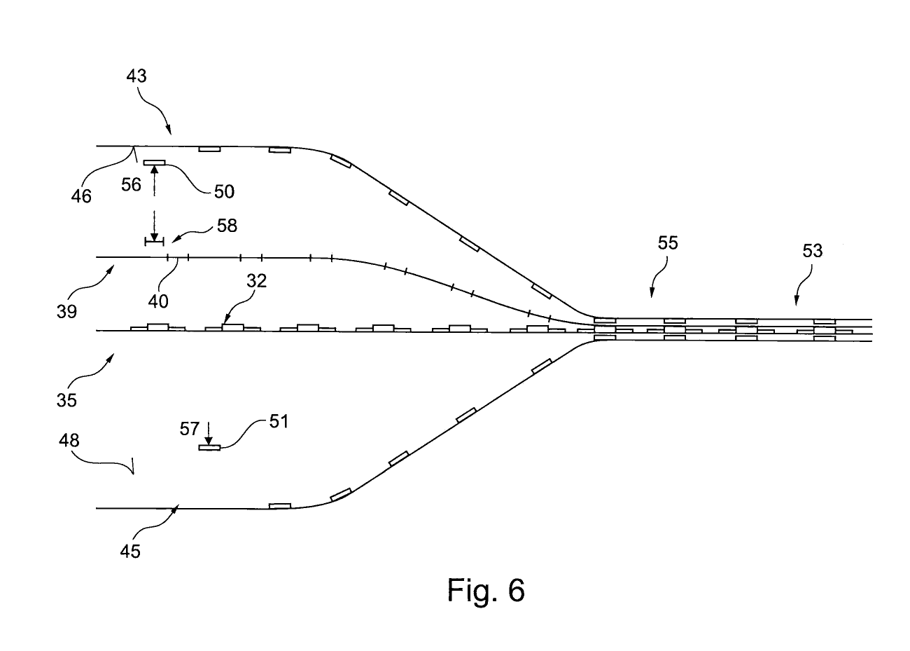

FIG. 6 shows, in a schematic illustration, a production method for producing the laminate structure illustrated in FIG. 4.

FIG. 1 shows a laminate structure 10 as a component of a contact chip card 11. The laminate structure 10 encompasses a base layer 12 comprising a recess 13 (FIG. 2) and a cover layer 14 applied to the base layer 12, which encompasses a window opening 15 (FIG. 2) overlapping the recess 13. Together with the window opening 15, the recess 13 forms an accommodating space 16 (FIG. 2) for accommodating a chip module 17. In the instant case, the chip module 17 is formed as a chip module for a contact card and, on an outer side of a chip carrier 18, encompasses a contact surface arrangement 19, which is provided for contacting correspondingly arranged contacts of a reading device, which is not illustrated in detail herein. On the side located opposite the contact surface arrangement 19, the chip carrier 18 is provided with a chip housing 20 in which a chip, which is not illustrated in detail herein, is arranged.

As is shown in FIG. 1, an intermediate space 22, which is formed between the chip module 17 and a surface 21 of the accommodating space 16, is filled with an adhesive material layer 23, which, in the case of the chip card 11 illustrated in FIG. 1, fills the intermediate space 22 after carrying out the laminating process and which forms a transition area 26 surrounding the contact surface 24 in a frame-like manner so as to be flush with a contact surface 24 of the chip module 17 and an outer surface 25 of the cover layer 14.

FIG. 2 shows the laminate structure 10 directly prior to the insertion of the chip module 17 into the accommodating space 16 prior to carrying out the laminating process. In this stage, the cover layer 14 with its window opening 15 is already arranged so as to overlap the recess 13 on the base layer 12. The adhesive material layer 23 is placed into the accommodating space 16, which is created in this manner, and thereby forms a lining for the accommodating space 16, which has a cup-shaped design.

As is further shown in FIG. 3, an extensive adaptation of the adhesive material layer 23 or the nestling of the adhesive material layer 23 against the surface 21 of the recess 16 already takes place by means of the insertion of the chip module 17 into the accommodating space 16, which results in an edge projection 27 of the adhesive material layer 23 in relation to the outer surface 25 of the cover layer 14. As a result of a subsequent laminating process, the flush arrangement (illustrated in FIG. 1) between the contact surface 24 of the chip module 17 and the outer surface 25 of the cover layer 14 then follows, wherein the transition area 26, which frames the contact surface 24 of the chip module 17, is formed.

FIG. 4 shows a laminate structure 30 for a contactless chip card 31, which encompasses a chip module 32 being contacted with contact ends 33, 34 of an antenna 36 arranged on a transponder layer 35. With its chip carrier 37, the chip module 32 is arranged in a window opening 38 of the transponder layer 35 and together with the transponder layer 35 forms individually manageable components of the laminate structure 30.

A cover layer 39, which, overlapping the window opening 38 of the transponder layer 35, is provided with a window opening 40, is located on the transponder layer 35. A chip housing 41 of the chip module 32, which accommodates a chip not illustrated in detail herein, projects into the window opening 40, so that an accommodating space 41 being formed by the window openings 38 and 40 accommodates the chip module 32.

As can further be seen from FIG. 4, a top side 42 of the cover layer 39 is covered with a top layer 43 and a bottom side 44 of the transponder layer 35 is covered with a bottom layer 45, so that the accommodating space 41 accommodates the chip module 32 so as to be closed towards the outside.

Between a bottom side 46 of the top layer 43 and the top side 42 of the cover layer 39 or a top side 47 of the chip module 32, respectively, as well as between a top side 48 of the bottom layer 45 and the bottom side 44 of the transponder layer 35 or a bottom side 49 of the chip module 32, respectively, adhesive material layers 50, 51, are located in each case, said adhesive material layers being formed so as to be interconnected, such that an intermediate space 61, which remains between a surface 52 of the accommodating space 41 and the chip module 32 in the laminate structure 30 being illustrated in FIG. 4 and being obtained after the laminating process has ended, is filled by the adhesive material of the adhesive material layers 50, 51. Adjoining the bottom side 46 of the top layer 43 as well as adjoining the top side 48 of the bottom layer 45, overlapping areas 53, 54, which laterally project beyond the chip module 32 and which accommodate the chip module 32 between each other in a sandwich-like manner, are formed.

FIG. 5 shows the laminate structure 30 directly prior to carrying out the laminating process, wherein the accommodating space 41 formed by the window openings 38, 40 is still free from adhesive material and the adhesive material in the form of the adhesive material layers 50, 51, which are still unformed, is only located opposite to the top side 47 of the chip module 32 and the bottom side 49 of the chip module 32.

In the case of a preferred alternative of the production method of the laminate structure 30 illustrated in FIGS. 4 and 5, in which the transponder layer 35, the cover layer 39, the bottom layer 45 and the top layer 43 are supplied to a laminate layer structuring station 55 (FIG. 6), the adhesive material layers 50, 51 are in each case applied to the bottom side 46 of the top layer 43 or the top side 48 of the bottom layer 45, respectively, in an adhesive material placement station 56, 57 prior to joining the individual layers in the laminate layer structuring station 55.

As is further shown in FIG. 6, the application of the adhesive material layers 50, 51 takes place synchronously with the cutting of the window opening 40 in the cover layer 39 in a cutting station 58. In the region of the laminate layer structuring station 55, the cover layer 39 as well as the top layer 43 and the bottom layer 45 are finally brought together with the transponder layer 35, which is also supplied endlessly, and can subsequently be prefixed in a fixing station 59 by applying ultrasound and pressure immediately prior to the actual laminating process in which the layers are joined.

Subsequent to the laminating process, a separation of the chip cards 31 from the laminate layer line, which has been brought together in the laminate layer structuring station 55, then takes place in a manner known per se, by means of cutting or other suitable separating measures.

1. A laminate structure for a chip card, said laminate structure comprising:
a base layer;
a chip module accommodated at least partially in the base Layer;
at least one cover layer that covers the base layer; and
an adhesive material disposed in an intermediate space formed between the chip module and the at least one cover layer and between the chip module and the base layer, wherein the adhesive material generates adhesive forces with respect to wetted surfaces of the base layer, the at least one cover layer, and the chip module.

2. The laminate structure according to claim 1, in which the adhesive material is chosen such that the ratio of the adhesive forces in relation to the base layer and the at least one cover layer with respect to the adhesive forces generated in relation to the chip module is 0.5 to 1.5.

3. The laminate structure according to claim 1, in which the adhesive material is made on an acrylate base.

4. The laminate structure according to claim 1, in which the adhesive material encompasses more than 50 percent by weight of acrylate.

5. The laminate structure according to claim 4, in which the adhesive material is formed as an adhesive material layer including a carrier layer and a coating of acrylate applied to both sides of the carrier layer.

6. The laminate structure according to claim 1, in which the base layer is formed as a transponder layer including an antenna formed on the transponder layer, and contact ends of said antenna are contacted with terminal faces of the chip module.

7. The laminate structure according to claim 6, in which a top side of the chip module is covered by a top layer arranged on the at least one cover layer and a bottom side of the chip module is covered by a bottom layer arranged on the transponder layer, wherein at least one window opening formed in the at least one cover layer and at least one window opening formed in the transponder layer, define an accommodating space for arranging the chip module, and are in each case covered with an adhesive material coating, which extends between the top side of the chip module and the top layer as well as between the bottom side of the chip module and the bottom layer.

8. The laminate structure according to claim 7, in which the transponder layer and the cover layer are formed by means of an upper part and a lower part of an inlay layer, which is formed in one piece.

9. A laminate structure according to claim 7, in which the adhesive material coating arranged on the top side of the chip module and the adhesive material coating arranged on the bottom side of the chip module in each case extend beyond the edge of the window opening between the top layer and the cover layer as well as between the bottom layer and the transponder layer.

10. The laminate structure according to claim 1, in which at least one of the base layer and the at least one cover layer is formed from polycarbonate.

11. A method for producing a laminate structure for a chip card including a base layer, a chip module accommodated at least partially in the base layer, and at least one cover layer that covers the base layer, said method comprising the steps of:
depositing an adhesive material between the at least one cover layer and the chip module as well as between the base layer and the chip module; and
laminating at least one cover layer, the chip module, and the base layer, wherein the volume of said adhesive material deposited being dimensioned such that an intermediate space formed between the chip module and the at least one cover layer as well as between the chip module and the base layer is filled with the adhesive material during the laminating step, wherein said adhesive material generates adhesive forces with respect to wetted surfaces of the base layer, the at least one cover layer, and the chip module.

12. The method according to claim 11, in which the adhesive material deposited is formed as an adhesive material layer inserted into an accommodating space being formed in the laminate structure for accommodating the chip module, such that the adhesive material layer covers a surface that delimits the accommodating space.

13. The method according to claim 12, in which the adhesive material layer is inserted into the accommodating space such that edges of the adhesive material layer project beyond the outer surface of the cover layer.

14. The method according to claim 11, including, forming the base layer is as a transponder layer including an antenna formed on the transponder layer and contact ends of said antenna are contacted with terminal faces of the chip module, wherein the adhesive material forms adhesive material layers arranged between a top side of the chip module and a top layer that covers the at least one cover layer, as well as between a bottom side of the chip module and a bottom layer that covers the transponder layer, wherein edges of the adhesive material layer project beyond a window opening formed in the cover layer and in the transponder layer.

15. The method according to claim 14, in which the adhesive material layers are formed as adhesive patches, a surface of which is dimensioned so as to project beyond the window opening.

16. The method according to claim 15, in which the adhesive material layers are applied to the bottom layer and the top layer prior to the laminating step.
